(19) United States
(12) Patent Application Publication
(10) Pub. No.: US 2008/0126490 A1
(43) Pub. Date: May 29, 2008

(54) METHOD AND APPARATUS FOR PRESENTING INFORMATION CONCERNING A SET OF INCOMING COMMUNICATIONS

(75) Inventors: Mark T. Ahlenius, Lombard, IL (US); Deborah A. Matteo, Schaumburg, IL (US); Prakairut Tarlton, Barrington, IL (US)

Correspondence Address: MOTOROLA, INC., 1303 EAST ALGONQUIN ROAD, IL01/3RD, SCHAUMBURG, IL, 60196, US

(73) Assignee: Motorola, Inc., Schaumburg, IL (US)

(21) Appl. No.: 11/564,393

(22) Filed: Nov. 29, 2006

(51) Int. Cl. G06F 15/16; G06F 7/00

(52) U.S. Cl. 709/206; 707/100; 707/E17.058

(57) ABSTRACT

A method (400) and an apparatus (600) for presenting information concerning a set of incoming communications includes determining and storing (405) data associated with each incoming communication of the set of incoming communications, identifying (410) a subset of communications-by-type from the set of incoming communications, determining (415) subsets of communications-by-originator from the subset of communications-by-type, determining for the subset of communications-by-type (420) a relative priority of the subsets of communications-by-originator, and presenting (425) information concerning the incoming communications of the subsets of communications-by-originator in an order determined by the relative priority.

### FIELD OF THE INVENTION

The present invention relates generally to electronic messaging devices, and more particularly to a user interface for electronic messaging devices.

### BACKGROUND

When a mobile telephone user is unable to answer incoming communications and view other events stored in the mobile telephone for a period of time, especially during working hours, the user must then step through each of the recent calls, emails, or calendar tasks, etc. to determine which the user needs to respond to or act upon. This may take some time, which can be a problem when there are several or many such recent incoming calls and upcoming events, because the user may have to review a list of all such items and guess which is the most important, possibly delaying the user's response to the most urgent items.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIGS. 1-3 are representations of information being presented on a display of an electronic communication device.

FIGS. 4 and 5 are flow charts of methods used in an electronic communication device, in accordance with certain embodiments.

FIG. 6 is an electronic block diagram of an electronic communication device, in accordance with certain embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail the following embodiments, it should be observed that the embodiments reside primarily in combinations of method steps and apparatus components related to presenting information concerning incoming communications received by an electronic communication device. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

In general, the methods described herein as Infosummary provide a concise summarization of “interesting” communications and task/event information for the user of an electronic communication device. The electronic communication device may be a cellular telephone or any personal communication device or telephone set that can receive incoming communications of at least one type, operating in a conventional wired, wireless, or broadband telephone system (such as cellular or voice over internet). This information may be presented to the user in an audible format or display format, or both, normally starting at a most general level. A dialog method allows the user to quickly work down to more specific information. As a setup action, the user can select which information topics to have displayed and the order in which they are presented via a graphical user interface (GUI) setup menu. These are stored as user settings.

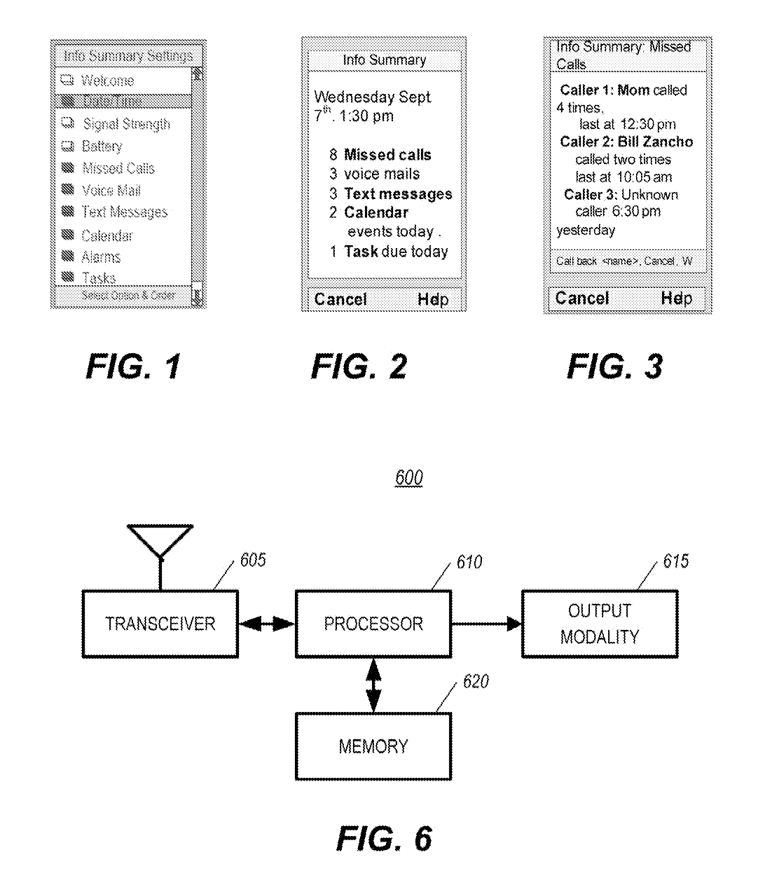

Referring to FIG. 1, a representation of a display of an electronic communication device shows one example of a list of information topics from which a user may select and order a particular set of information topics as user settings, in accordance with some of the embodiments. The information topics from which the user may select topics include: welcome message, date/time, signal strength, battery, missed calls, voice mail messages, text messages, calendar events, alarms, and tasks.

The user settings are accessed by a processor of the electronic communications device to use for gathering information on each topic identified by the settings. A summary of data about the information topics is then presented to the user in an order determined from the user settings. By default (if the user has not selected a set of information topics and their order that have been stored in the user settings) the following information topics are presented to the user in a default order (these can be changed by the user):

a. Welcome

b. Date/Time

c. Missed Calls

d. Voice Mails

e. Text Messages

f. Calendar

g. Alarms

Referring to FIG. 2, a representation of the display of the electronic communication device shows a summary of information that has been organized according to the user settings of FIG. 1, in accordance with some of the embodiments. This summary of information may be presented in response to a command from a user of the electronic communications device. The information shown on the display is an example of a first presentation of information topics using a high level summary. The information shown in this example includes missed calls, voice mails, text messages, calendar events, and tasks, showing a quantity of each. The quantities of voice mails and text messages may be counts of those for which no response has been made. More specifically the quantity of missed calls is a count of those that have been received but not answered, the quantity of voice mails is a count of those that have not been presented to the user, and the quantity of text messages is a count of those that have been received but not presented to the user. In some embodiments, the quantities of text messages and/or voice mails may be a count of those that have not been deleted, irrespective of whether they have been presented. The quantity of calendar events and tasks may be a count of those remaining in the day, or some other period determined by default or the user. The quantities of other incoming communications (e.g., voice message or emails) may be treated similarly. When the quantity related to an information topic is zero, then the summary of that topic is not presented.

The presentation of the information on the display may be accompanied by a simultaneous presentation of the information generated by a text to voice output modality of the electronic communication device. In response to the presentation of the summary information described herein with reference to FIG. 2, the user may select one of the information topics. Those information topics which are related to messages, that is—telephone calls, multimedia messages, voice mail, voice messages, email, and text messages—are also referred to as types of incoming communications, so it may be said that the user may select one type of information topic. The electronic communication device uses the selection to determine and present a summary list of incoming communications by originator, for the type selected, presented in an order of relative priority. Note that in accordance with certain embodiments, the user may select any of this information using either the keypad, tactile input, and/or spoken commands. Also note that, depending on the embodiments, the information output can be either graphical, audio or both. It should be appreciated that the terms “originator” and “caller” as used hereafter are basically synonymous, and may be differentiated in some embodiments from an identity of the telephony device or phone number used to make a call.

Referring to FIG. 3, a representation of the display of the electronic communication device shows a summary of missed calls, in accordance with some embodiments. This is but one example of a summary list of incoming communications by originator, for a selected type (missed calls). A similar summary may be presented for other types of incoming communications, when sufficient data can be determined for the incoming communications. This unique aspect of the Infosummary method typically allows the user to become aware of the phone calls or other incoming messages of the most important originator first. This can be particularly important when, for example, the user of the electronic communication device has had the device operating for some time (such as an hour) in a profile such as a meeting profile, during which the user is not presented or does not see incoming communications. Upon the completion of the meeting, the user can obtain a list of, for example, his missed phone calls in order of their priority.

In some embodiments, the relative priority of the originators can be determined by user settings for callers that are, for example, stored in the user's contact database of the electronic communication device. In other embodiments, the relative priority is determined by other factors, as will be described below. For the example of FIG. 3, it can been seen that the originators of the missed calls are identified with an index number (“Caller 1”, “Caller 2” . . . ) according to their priority, then by their name (if known), followed by a summarization of their calls. The caller name may be obtained in some instances through caller ID, by automatic speech recognition, or by reverse lookup in the contacts database of the electronic communication device. In this example, the summarization of their calls includes a quantity of the missed calls and a time of the most recent missed call. Incoming communications made by one originator using a plurality of originating devices that are associated with the one user by the electronic communication device may be counted as incoming communications of one type for one originator. For example, a caller may be associated with a home phone number, a work phone number, and a cellular telephone number in the contacts database of the electronic communication device. These may all be counted as missed calls for the caller. Or, a caller may be associated with a home email address and a work email address in the contacts database of the electronic communication device, which may be counted as missed emails for the caller.

The user may then, in some embodiments, select a caller number and either compose a response (such as a text message, voice message, or email) and indicate for the response to be sent, or indicate that a phone call is to be placed. The electronic communication device determines an origin of a most recent notification of an incoming communication of the type selected and sends the response or places the phone call to that origin. In this instance, the term “notification” may include actual receipt of a communication, such as a text message, and may include other types of notification, such as an unanswered telephone call, or a notice of an incoming communication held at a server, such as an email. In one example, when the caller has a home phone, a work phone, and a cellular telephone, the electronic communication device may place a call to the device which was the origin of the most recent incoming communication of the type selected. For this feature to operate well, a time of the notification may also be captured as a part of the metadata associated with incoming messages.

When the user has caused the electronic communication device to present a summary list of incoming communications by originator, for a selected type, the incoming communications presented are marked or otherwise identified within the electronic communication device so that they are not counted in any future request for presentation of a summary list of incoming communications by originator, for that selected type and originator.

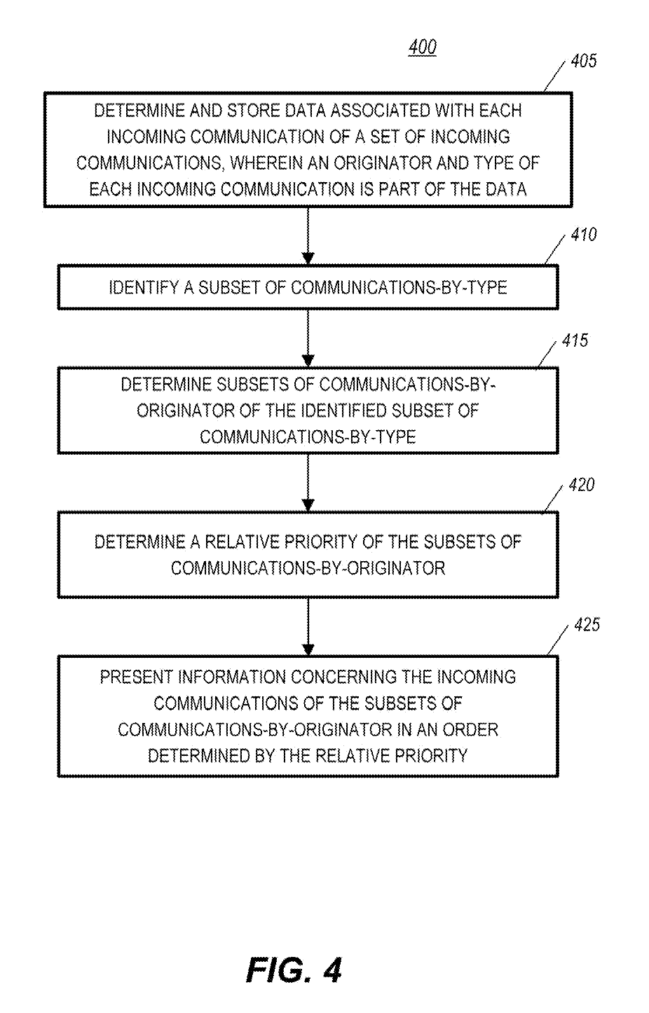

Referring to FIG. 4, a flow chart shows some steps of a method 400 for presenting information concerning a set of incoming communications received by an electronic communication device, in accordance with some embodiments. At step 405, data associated with each incoming communication of the set of incoming communications is determined and stored, wherein an originator and a type of each incoming communication is part of the data. This data may be acquired as each incoming communication is received. One subset of a plurality of subsets of communications-by-type is determined at step 410 from the set of incoming communications. This step may be repeated for each type of incoming communication that is in the set of incoming communications. At step 415, subsets of communications-by-originator are determined from each subset of communications-by-type, wherein the originator may be a caller who has used different telephony devices and/or phone numbers. These determinations of subsets of communications-by-type and subsets of communications-by-originator may be performed as each incoming communication is received, or at a time when a user request presentation of information that requires such determinations, or using other methods of meta-data gathering known to those of ordinary skill in the art. At step 420, a relative priority of the subsets of communications-by-originator is determined for an identified subset of communications-by-type. The identification of a subset of communications by type may be performed in some embodiments by sensing of a user input, or in some embodiments, by selecting an incoming communication type having a highest priority of incoming communication types and having at least one incoming communication. The relative priority of the subsets of communications-by-originator may be determined by default or user settings in certain embodiments. In certain embodiments, the relative priority of the subsets of communications-by-originator may be determined based on at least one of a group of priority factors including a time weighted quantity of incoming communications from each originator, a time weighted quantity of response communications to each originator; a time weighted response delay time for each originator; an assigned default priority, a device context, and a user context.

An exemplary expression for calculating the priority for phone calls from one originator could be:

$${PRIORITY}_{Originator} = {a}_{Quan} {\sum }_{t = LRC}^{t = 0} MC + {a}_{Rel} \sum \frac{RC \times {TDF}_{i}}{{SC}_{i}} + {a}_{Del} {\sum }_{j} {( {t}_{RC} - {t}_{SC} )}_{j} \times {TDF}_{j} + {a}_{Def} {DP}_{Orig} + {a}_{Con} \times f ( TOD , LOC , DOW )$$

### Wherein:

$${a}_{Quan} {\sum }_{t = LRC}^{t = 0} MC$$

represents the weighted time dependent quantity of calls from an originator, in which a_{Quan} is a weighting and normalizing coefficient and

$${\sum }_{t = LRC}^{t = 0} MC$$

is a quantity of missed calls from a time of a last returned call or a default maximum time, to the present;

$${a}_{Rel} {\sum }_{i} \frac{RC \times {TDF}_{i}}{{SC}_{i}}$$

represents the weighted time dependent response call reliability for an originator, in which in which a_{Rel} is a weighting and normalizing coefficient and

$${\sum }_{i} \frac{RC \times {TDF}_{i}}{{SC}_{i}}$$

is a time dependent average quantity of responses (RC) to each call (SC) from each originator. The time dependent function TDFᵢ may be, for example,

$${e}^{- \frac{{t}_{i}}{T}} ,$$

wherein T is a time constant. The quantity of returned calls RC is determined over the time period of the sent calls (SC), which may be limited to some maximum quantity of sent calls or a maximum time, or other major event such as power down. In this embodiment of this part of the method, RCᵢ is simply a quantity of calls from the originator, each of which may or may not be a reply to a call sent by the user of the electronic communication device.

$${a}_{Del} {\sum }_{j} {( {t}_{RC} - {t}_{SC} )}_{j} \times {TDF}_{j}$$

represents the weighted time dependent response delay time for each originator, in which in which a_{Del} is a weighting and normalizing coefficient, and for which response delays are measured automatically using reply calls or by tying a reply to a previous sent call using contact information to match the receiver of the sent call to the originator of the reply call. In this embodiment of this part of the method, t_{RC} is a time of a reply call made in response to a sent call that was transmitted at time t_{SC}. The time decay factor TDFⱼ may be a time dependent function such as, for example,

$${e}^{- \frac{{t}_{j}}{T}} .$$

a_{Def}DP_{Orig} represents a weighted, assigned default priority, in which in which a_{Def} is a weighting and normalizing coefficient and for which the default priority of an originator, DP_{Orig}, may be a value assigned by the user of the electronic communication device and stored in, for example, the user settings table.

a_{Con}×f(TOD,LOC, DOW) represents a weighted user context, in which in which a_{Con} is a weighting and normalizing coefficient for which the user context, f(TOD, LOC, DOW), may be a function of one or more of the time of day (TOD), the user's location (LOC), and the day of week (DOW)—which can also include holidays. In some embodiments, the user context could be expanded to a joint user-originator context that includes the identity of the originator and the location of the originator.

It will be appreciated that the above example of determining a relative priority of an originator's call is but one example of many that could be devised by one of ordinary skill in the art, based on these or similar factors. It will be further appreciated that the above example could be based on any subset of the factors listed by setting one or more of the weighting and normalizing coefficients to zero. It will be further appreciated that factors such as some or all of those provided above could be used for type of communications other than phone calls—e.g., text messages, emails, and multimedia messages.

In some embodiments, the relative priority determination step could be replaced by a neural network that has as inputs the same information used for the above formulaic approach. The neural network could be designed to have default training that is used initially, followed by training that occurs by means of user feedback during normal operation, indicating when the result determined by the neural network is good or bad.

At step 425, information concerning the incoming communications of the subsets of communications-by-originator is presented in an order determined by the relative priority. FIG. 3 showed an example of this.

In certain embodiments, all incoming communications that would otherwise be of the types described above as incoming communications for which no response has been made may grouped in a subset that is then sorted by originator. In these embodiments, presentation to the user would be made in order of priority of originator, as described above with reference to FIGS. 1-4, but the type of incoming communication may not need to be determined. These embodiments use steps of a method 500 that is illustrated by reference to FIG. 5. These steps are very similar to the steps described with reference to FIG. 4, with one step eliminated and references to subsets of incoming communications-by-type removed.

It will be appreciated that embodiments of the invention described herein may be comprised of one or more conventional processors and unique stored program instructions that control the one or more processors to implement, in conjunction with certain non-processor circuits, some, most, or all of the functions of the embodiments of the invention described herein. The non-processor circuits may include, but are not limited to, a radio receiver, a radio transmitter, signal drivers, clock circuits, power source circuits, and user input devices. As such, these functions may be interpreted as steps of a method for presenting information concerning a set of incoming communications. Alternatively, some or all functions could be implemented by a state machine that has no stored program instructions, or in one or more application specific integrated circuits (ASICs), in which each function or some combinations of certain of the functions are implemented as custom logic. Of course, a combination of these approaches could be used. Thus, methods and means for these functions have been described herein. In those situations for which functions of the embodiments of the invention can be implemented using a processor and stored program instructions, it will be appreciated that one means for implementing such functions is the media that stores the stored program instructions, be it magnetic storage or a signal conveying a file. Further, it is expected that one of ordinary skill, notwithstanding possibly significant effort and many design choices motivated by, for example, available time, current technology, and economic considerations, when guided by the concepts and principles disclosed herein will be readily capable of generating such stored program instructions and ICs with minimal experimentation.

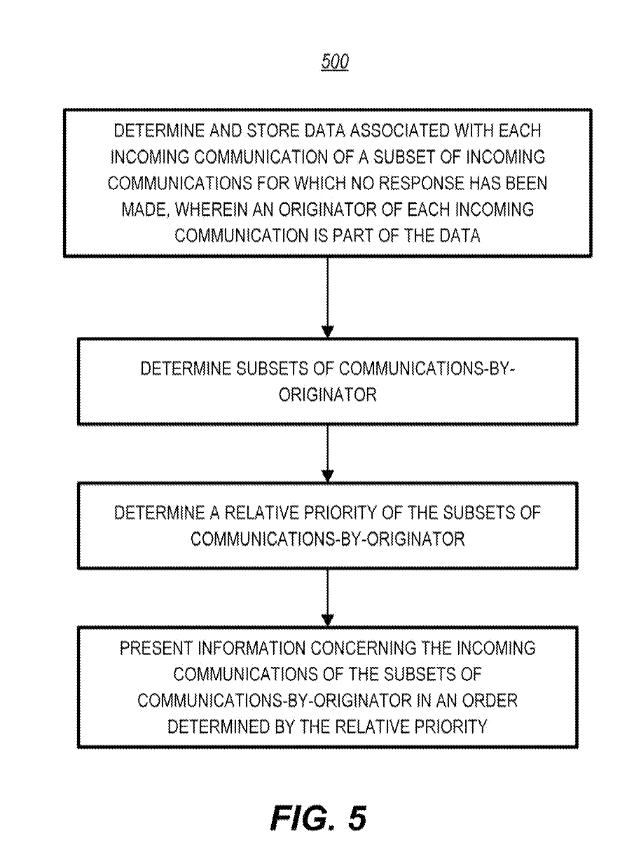

Referring to FIG. 6, an electrical block diagram illustrates an electronic communication device 600 in accordance with certain embodiments. The electronic communication device 600 comprises, among other things, a processor 610, a transceiver 605, an output modality 615 and a memory 620. As indicated above, the processor 610 may actually comprise more than one processor, operating cooperatively. The memory 620 may include several different types of memory, and includes stored program instructions that control the processor 610 to: determine and store data associated with each incoming communication of a set of incoming communications received by transceiver 605, wherein an originator and a type of each incoming communication is part of the data; identify a subset of communications-by-type from the set of incoming communications; determine subsets of communications-by-originator from the subset of communications-by-type; determine for the subset of communications-by-type a relative priority of the subsets of communications-by-originator; and present information concerning the incoming communications of the subsets of communications-by-originator in an order determined by the relative priority.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method of presenting information concerning a set of incoming communications, comprising:
determining and storing data associated with each incoming communication of the set of incoming communications, wherein an originator and a type of each incoming communication are part of the data;
identifying a subset of communications-by-type from the set of incoming communications;
determining subsets of communications-by-originator from the subset of communications-by-type;
determining for the subset of communications-by-type a relative priority of the subsets of communications-by-originator; and
presenting information concerning the incoming communications of the subsets of communications-by-originator in an order determined by the relative priority.

2. The method of claim 1, wherein the relative priority is determined based on at least one of a group of priority factors comprising:
a time weighted quantity of incoming communications from each originator;
a time weighted quantity of response communications to each originator;
a time weighted response delay time for each originator;
an assigned default priority,
a device context, and
a user context.

3. The method of claim 2, wherein the relative priorities are determined by combining the at least one of a group of priority factors in a weighted manner.

4. The method of claim 2, wherein the incoming communications used for the time weighted quantity of incoming communications from each originator, the response communications used for the time weighted quantity of response communications to each originator, and the responses used for the time weighted response delay time for each originator are of the same type of communications as that for which the relative priority is being determined.

5. The method of claim 1, wherein the type of incoming communications is one of electronic mail (email), voice mail, text message, voice message, multimedia message, missed call, received call, event and task.

6. The method of claim 1, wherein the information concerning the incoming communications of the subsets of communications-by-originator is presented using both voice and a graphical user interface output modalities.

7. The method of claim 1, further comprising, after determining and storing data associated with each incoming communication presenting a quantity of each of at least one type of incoming communications for which no response has been made, wherein the subset of communications-by-type is identified by a user input after the presentation of the least one type of incoming communications for which no response has been made

8. The method of claim 7, wherein the at least one type of incoming communication for which no response has been made is one or more of missed telephone call, unpresented multimedia message, unanswered electronic mail, unread text message, unplayed voice mails and unplayed voice messages.

9. The method of claim 1, wherein an origin and time of notification of each of the incoming communications is a part of the data associated with each incoming communication that is determined and stored, further comprising:
identifying a subset of the subsets of communications-by-originator for which a response is to be generated;
formulating the response; and
sending the response to the origin of a most recent incoming communication of the identified subset of the subsets of communications-by-originator.

10. The method of claim 1, further comprising:
receiving a new incoming communication;
determining an originator and type of the new incoming communication; and
augmenting the subset of communications-by-originator of the subset of communications-by-type that is associated with the originator and type of the new incoming communication.

11. A communication apparatus comprising:
a processor;
a transceiver;
an output modality; and
a memory storing programmed instructions controlling the processor to:
determine and store data associated with each incoming communication of the set of incoming communications, wherein an originator and a type of each incoming communication is part of the data;
identify a subset of communications-by-type from the set of incoming communications;
determine subsets of communications-by-originator from the subset of communications-by-type;
determine for the subset of communications-by-type a relative priority of the subsets of communications-by-originator; and
present information concerning the incoming communications of the subsets of communications-by-originator in an order determined by the relative priority.

12. A method of presenting information concerning a set of incoming communications, comprising:
determining and storing data associated with each incoming communication of a subset of the set of incoming communications comprising incoming communications for which no response has been made, wherein an originator of each incoming communication is part of the data;
determining subsets of communications-by-originator;
determining a relative priority of the subsets of communications-by-originator; and
presenting information concerning the incoming communications of the subsets of communications-by-originator in an order determined by the relative priority.
